(19) United States
(12) Patent Application Publication
(10) Pub. No.: US 2021/0112779 A1
(43) Pub. Date: Apr. 22, 2021

(54) ANIMAL WASTE COLLECTION WEARABLE

(71) Applicant: Arnel CASTRO, Santa Clara, CA (US)

(72) Inventor: Arnel CASTRO, Santa Clara, CA (US)

(21) Appl. No.: 17/003,998

(22) Filed: Aug. 27, 2020

Related U.S. Application Data
(60) Provisional application No. 62/916,615, filed on Oct. 17, 2019.

(51) Int. Cl. A01K 23/00; A01K 27/00

(52) U.S. Cl. CPC A01K 23/00; A01K 27/002

(57) ABSTRACT

Embodiments of the present disclosure provide an animal waste collection wearable. The wearable includes a harness member for mounting to a body of an animal. The harness member covers a hind end of the animal while exposing a tail and an anal area of the animal through an opening. The harness member includes a plurality of leg strap members configured to wrap around hind legs of the animal and releasably engage with a fastening means for mounting the harness member to the body of the animal. A first hook member and a second hook member configured on a left arm and a right arm of the opening, respectively and are adapted for securing a waste collection bag to the harness member. The waste collection bag removably mounted to the harness member conceals the opening and ensures complete entrapment of the anal area for collecting excrement of the animal.

### TECHNICAL FIELD

The present disclosure relates to an animal wearable and, more particularly relates, to a wearable for collecting excrement of an animal.

### BACKGROUND

A domestic or tamed animal may be owned by a person (i.e., owner) for companionship or pleasure. The owner spends time with his/her pets and regularly engages in physical activities, such as exercise, walking with their pets that not only improves the health condition of the owner but also ensures that the pet stays active and healthy. Moreover, a daily walk with the pets is important as it provides them with exercise and time to relieve themselves through urination and excretion. When engaging the pets outdoors, the owners are responsible to pick up waste matter (feces) after their pet excretes.

Conventionally, the owners manually pick up the feces with their hands covered with a plastic bag or clean the feces using tools like brooms and dispose of it in a plastic bag. In such cases, the plastic bag must be sufficient enough, so that the owner's hands can be inserted inside the plastic bag to prevent themselves from making direct contact with the feces during the collection. The usage of plastic bags for picking up and disposing of the feces harms the environment. Moreover, collection and disposing of the waste matter is an unsettling task and can be unappealing for the pet owners as they are required to interact with the feces. Further, the owners are also subjected to the unpleasant nature of the texture, temperature, smell, and harmful micro-organisms of the feces. Some socially anxious owners may be embarrassed to pick up the feces in public places. Moreover, certain groups of people such as those with disabilities and physical limitations (e.g., the elderly) may also find it difficult to pick up the feces from the ground. Further, if the feces are not cleaned up, they may pose safety and hygiene issues in the surrounding.

In one case, the owners may use a handheld waste collector apparatus (e.g., scoopers) with short handles for collecting the feces of the pets. Such short handles of the apparatus require the owner to stoop to the ground to collect and retrieve the waste matter, which may be difficult for people with physical limitations and the elderly. In another case, the pets may be equipped with a diaper garment to collect the waste matter. However, the diaper garment may cause discomfort for the pets as they carry the feces and move around. Moreover, the feces collected in the diaper garment may be dropped onto the ground when the pets move due to discomfort caused by the diaper garment.

Therefore, there exists a need for techniques that eliminates the owner from directly interacting with the feces of the animal during the defecation process.

### SUMMARY

Various embodiments of the present disclosure provide an animal waste collection wearable.

In an embodiment, an animal waste collection wearable is disclosed. The animal waste collection wearable includes a harness member for mounting to a body of an animal. The harness member is configured to cover at least a portion of a hind end of the animal. The harness member includes an opening at a distal portion of the harness member. The opening is configured to expose a tail and an anal area of the animal when the harness member is secured to the body of the animal. The harness member further includes a plurality of leg strap members configured to wrap around at least hind legs of the animal. The plurality of leg strap members extend from a bottom end of each of a left arm and a right arm of the opening and releasably engage with a fastening means at a proximal portion of the harness member for mounting the harness member to the body of the animal. The harness member includes a first hook member and a second hook member configured proximate to a top end and the bottom end of each of the left arm and the right arm of the opening, respectively. The animal waste collection wearable further includes a waste collection bag removably mounted at the distal portion of the harness member through the first hook member and the second hook member to conceal the opening and for complete entrapment of the anal area of the animal. The waste collection bag is configured to collect the excrement of the animal.

In another embodiment, an animal waste collection wearable is disclosed. The animal waste collection wearable includes a harness member configured for mounting to a body of an animal. The harness member is configured to cover at least a portion of a hind end of the animal. The harness member includes an opening configured at a distal portion of the harness member. The opening is configured to expose a tail and an anal area of the animal when the harness member is secured to the body of the animal. The harness member further includes a plurality of leg strap members configured to wrap around at least hind legs of the animal. The plurality of leg strap members extend from a bottom end of each of a left arm and a right arm of the opening and releasably engage with a fastening means at a proximal portion of the harness member for mounting the harness member to the body of the animal. The harness member includes a first hook member and a second hook member configured proximate to a top end and the bottom end of each of the left arm and the right arm of the opening respectively. The animal waste collection wearable includes a waste collection bag is removably mounted at the distal portion of the harness member through the first hook member and the second hook member to conceal the opening and for complete entrapment of the anal area of the animal. The waste collection bag is configured to collect the excrement of the animal. The waste collection bag includes a first strap member and a second strap member configured on a first side and a second side of the waste collection bag respectively. The first strap member and the second strap member are adapted to releasably engage with the first hook member and the second hook member respectively, for mounting the waste collection bag to the harness member.

In yet another embodiment, an animal waste collection wearable is disclosed. The animal waste collection wearable includes a harness member configured for mounting to a body of an animal. The harness member is configured to cover at least a portion of a hind end of the animal. The harness member includes an opening configured at a distal portion of the harness member. The opening is configured to expose a tail and an anal area of the animal when the harness member is secured to the body of the animal. The harness member further includes a plurality of leg strap members configured to wrap around at least hind legs of the animal. The plurality of leg strap members extend from a bottom end of each of a left arm and a right arm of the opening and releasably engage with a fastening means at a proximal portion of the harness member for mounting the harness member to the body of the animal. The harness member includes an adjustable strap member including a first end secured to the proximal portion of the harness member and a second end configured with a fastening mechanism to releasably engage with a securing element configured on a collar secured to a neck of the animal. The fastening mechanism is engaged with the securing element by adjusting a length of the adjustable strap member based on a torso length of the animal. Further, the harness member includes a first hook member and a second hook member configured proximate to a top end and the bottom end of each of the left arm and the right arm of the opening respectively. The animal waste collection wearable further includes a waste collection bag removably mounted at the distal portion of the harness member through the first hook member and the second hook member to conceal the opening and for complete entrapment of the anal area of the animal. The waste collection bag is configured to collect the excrement of the animal. The waste collection bag includes a first strap member and a second strap member configured on a first side and a second side of the waste collection bag respectively. The first strap member and the second strap member are adapted to releasably engage with the first hook member and the second hook member respectively, for mounting the waste collection bag to the harness member.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1 illustrates an animal mounted with an animal waste collection wearable and an enlarged portion thereof, in accordance with an example embodiment of the present disclosure;

FIG. 2A illustrates a perspective view of a harness member and an enlarged portion thereof depicting a distal portion, in accordance with an example embodiment of the present disclosure;

FIG. 2B illustrates a top view of the harness member of FIG. 2A, in accordance with an example embodiment of the present disclosure;

FIG. 3A illustrates a perspective view of a waste collection bag in a collapsed form, in accordance with an example embodiment of the present disclosure;

FIG. 3B illustrates a side view of the waste collection bag in the collapsed form, in accordance with an example embodiment of the present disclosure;

FIG. 3C illustrates a perspective view of the waste collection bag in an expanded form, in accordance with an example embodiment of the present disclosure;

FIG. 3D illustrates a schematic representation of the waste collection bag in the expanded form configured to a closed position, in accordance with an example embodiment of the present disclosure;

FIG. 4 illustrates a schematic representation of the animal waste collection wearable with the waste collection bag in the extended form indicating collection of the excrement of the animal, in accordance with an example embodiment of the present disclosure;

FIGS. 5A and 5B illustrate stepwise process for mounting the waste collection bag to the harness member secured to the animal and an enlarged portion thereof depicting a mounting process, in accordance with an example embodiment of the present disclosure; and

FIGS. 6A and 6B illustrate stepwise process for disengaging the waste collection bag filled with the excrement from the harness member secured to the animal and an enlarged portion thereof depicting a disengagement process, in accordance with an example embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The terms “user” and “owner” have been used interchangeably throughout the description and refer to a person, a caretaker, or a group who own or take care of domestic animals (e.g., dogs, cows). Further, the terms “waste matter” and “excrement” have been used interchangeably throughout the description and refer to solid bodily waste and liquid waste discharged from the animals through the anus and/or an anal canal during defecation.

### Overview

Various embodiments of the present disclosure provide an animal waste collection wearable. In one embodiment, the animal waste collection wearable is mounted to an animal for collecting excrement of the animal. The animal waste collection wearable includes a harness member and a waste collection bag. The harness member is a pentagon-shaped structure that is configured to cover at least a portion of a hind end of the animal when secured to a body of the animal. The harness member includes a proximal portion and a distal portion. The harness member includes an opening configured at the distal portion. The opening exposes a tail and an anal area of the animal when the harness member is secured to the body of the animal.

The harness member includes a plurality of leg strap members extending from a bottom end of each of a left arm and a right arm of the opening respectively. The leg strap members are wrapped around at least hind legs of the animal and releasably engage with a fastening means of the harness member thereby mounting the harness member to the animal. The harness member includes an adjustable strap member having a first end secured to the proximal portion and a second end configured with a fastening mechanism. The fastening mechanism is configured to releasably engage with a securing element configured on a collar secured to a neck of the animal, based on adjusting the length of the adjustable strap member. The adjustable strap member includes a strap keeper for securing a remaining length of the adjustable strap member upon adjustment of the length of the adjustable strap member. The harness member further includes a first hook member and a second hook member configured proximate to a top end and the bottom end of each of the left arm and the right arm of the opening, respectively. The first hook member and the second hook member are securing means adapted for securing the waste collection bag to the harness member.

The waste collection bag includes a first strap member and a second strap member configured on a first side and a second side of the waste collection bag respectively. The waste collection bag is mounted to the harness member by releasably engaging the first strap member and the second strap member with the first hook member and the second hook member, respectively. Initially, the waste collection bag is mounted to the harness member in a collapsed form. The waste collection bag mounted in the collapsed form conceals the opening that exposes the anal area of the animal. The waste collection bag further includes a string member. A ring member is mounted to a distal end of the string member. A closure member is slidably mounted to the string member and adapted to move along the length of the string member for configuring the waste collection bag to an open position and a closed position. The distal end of the string member is pulled towards a latching member of the harness member for engaging the ring member with the latching member upon mounting the waste collection bag to the harness member. The closure member is moved towards the distal end of the string member configuring the waste collection bag to the open position for receiving excrement of the animal through an aperture of the waste collection bag. The closure member is moved beyond a proximal end of the string member upon detaching from the harness member for configuring the waste collection bag to the closed position and sealing the waste collection bag filled with excrement.

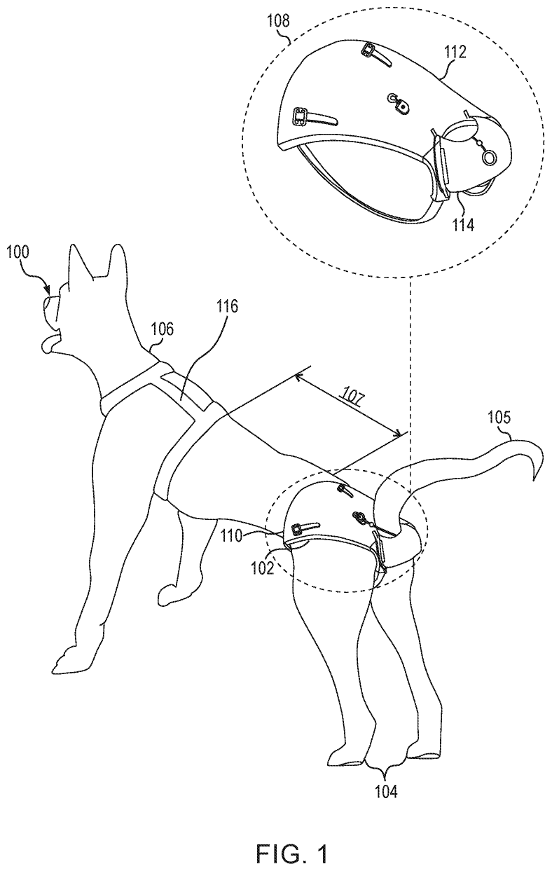

Various embodiments of an animal waste collection wearable for collecting animal excrement are described with reference to FIG. 1 to FIGS. 6A-6B.

FIG. 1 illustrates an animal 100 mounted with an animal waste collection wearable 110 and an enlarged portion 108 thereof depicting the animal waste collection wearable 110. The animal waste collection wearable 110 is configured to collect the excrement of the animal 100. In an embodiment, the animal waste collection wearable 110 covers at least a portion of a hind end 102 of the animal 100. In other words, the animal waste collection wearable 110 covers a portion of the back, loin, hip and croup of the animal 100. More specifically, the animal waste collection wearable 110 is a pentagon-shaped structure that snugly fits to a body of the animal 100. The animal waste collection wearable 110 includes a harness member 112 and a waste collection bag 114 (see, the enlarged portion 108).

The harness member 112 is configured to securely mount the animal waste collection wearable 110 to the animal 100. The harness member 112 is secured to at least hind legs 104 of the animal 100. In one non-limiting example, the animal 100 is a dog. However, it must be apparent that the harness member 112 may be mounted to any domestic animal (e.g., cow, horse) with a body structure similar to that of the dog for collecting the excrement of the animal 100. Thus, the harness member 112 may be designed in conformity with the body structure of other animals for mounting onto it. The harness member 112 includes an opening that exposes a tail 105 and an anal area (not shown in FIG. 1) of the animal 100. The waste collection bag 114 is mounted to the harness member 112 so as to conceal the anal area of the animal 100. The waste collection bag 114 may be configured based at least on dimensions of the opening in the harness member 112 and the size of the animal 100 so as to completely cover the anal area of the animal 100. The waste collection bag 114 is contracted and appears compact when initially mounted on the harness member 112. When the animal 100 defecates, the waste collection bag 114 expands to receive the excrement. The waste collection bag 114 may be disengaged from the harness member 112 and sealed for disposing of the excrement of the animal 100.

In some example embodiments, the harness member 112 is connected to a collar 116 by means of a strap (not shown in FIG. 1) that is secured to a neck 106 of the animal 100. The strap (see, adjustable strap member 212) is adapted to suit a torso length (see, 107) of a variety of animals and/or animal breeds. More specifically, the harness member 112 is secured to the collar 116 so as to prevent the harness member 112 from coming off the hind end 102 of animals that have no tail or a short tail.

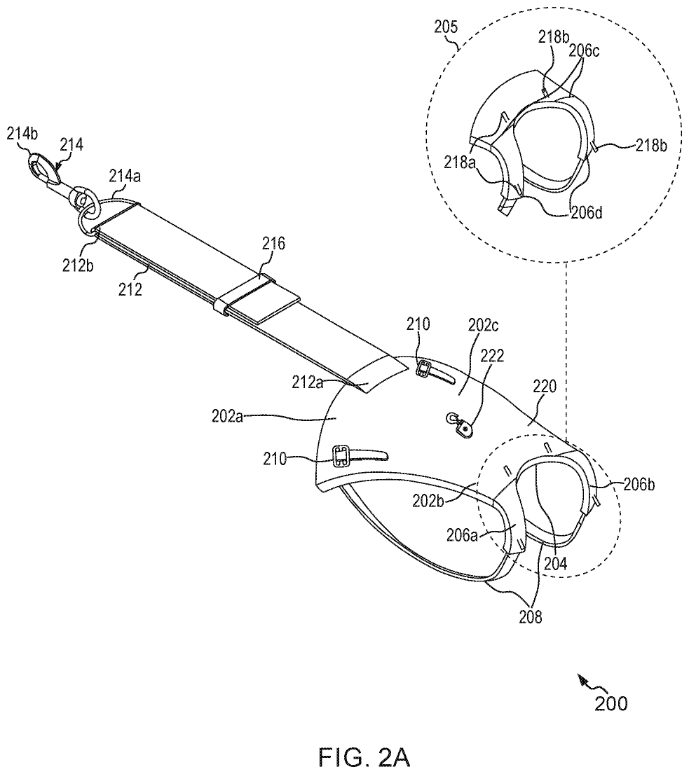

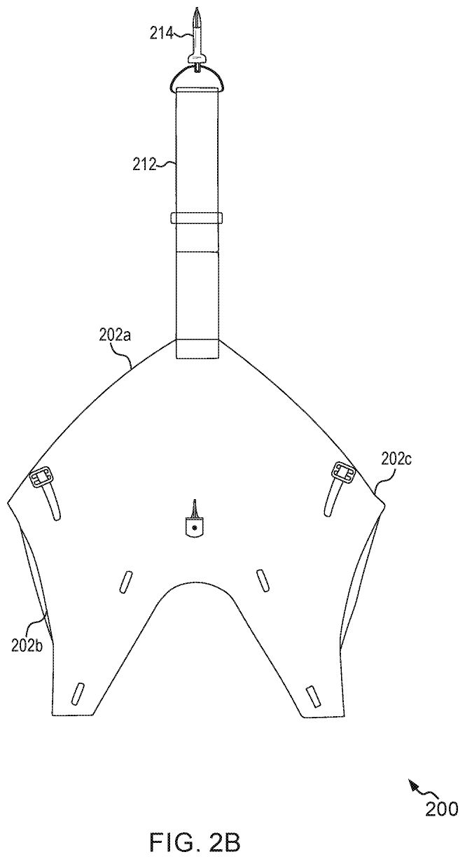

FIGS. 2A and 2B in one exemplary embodiment of the present disclosure illustrate a harness member 200 and an enlarged portion 205 thereof. The harness member 200 is an example of the harness member 112 shown and explained with reference to FIG. 1. The harness member 200 is a wearable device for mounting to a body of an animal, such as the animal 100. In an embodiment, the harness member 200 is configured to cover at least a portion of a hind end 102 of the animal 100.

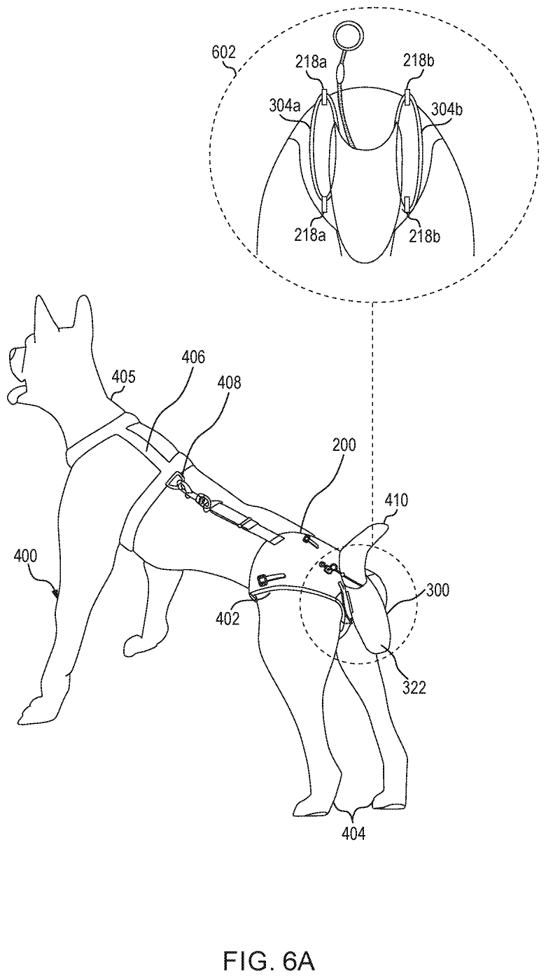

The harness member 200 includes a proximal portion 202a and a distal portion 202b. The distal portion 202b of the harness member 200 is configured to include a cut-out and is referred to as an opening 204 of the harness member 200. The opening 204 is configured so as to expose the tail 105 and the anal area (see, 412 in FIG. 5A) of the animal 100 when the harness member 200 is mounted on the animal 100. More specifically, when the harness member 200 is mounted on the animal 100, the opening 204 is positioned to receive the tail 105 of the animal 100 to be inserted therethrough and exposes the anal area of the animal 100. The opening 204 allows the animal 100 to excrete and move the tail 105 without any hindrance. In some example embodiments, the harness member 200 may include two separate openings (not shown in FIGS) for receiving the tail 105 to be inserted therethrough in one opening and another opening for the anal area.

In one embodiment, the cut-out at the distal portion 202b (i.e., the opening 204) is an inverted U-shaped structure when the harness member 200 is mounted to the animal 100. Alternatively, the opening 204 may be configured to assume different structures, for example, a circular/oval structure based on design feasibility and requirements. The inverted U-shaped structure of the opening 204 allows the harness member 200 to be used by the animal 100 without the utilization of an adjustable strap member 212 which is explained further in detail. The inverted U-shaped structure is butted up and fits snug against the tail 105 of the animal 100 when worn thereby preventing the harness member 200 from coming off the hind end 102 of the animal 100.

As shown in FIG. 2B, the harness member 200 may be configured to assume a pentagon shape. This configuration of the harness member 200 allows for a comfortable fit onto the animal 100 when the harness member 200 is mounted on the animal 100. However, it shall be apparent to a person skilled in the art that the harness member 200 may be configured in different shapes so as to enable a comfortable fit when worn by the animal 100.

The harness member 200 may be made of foam material and wrapped with a piece of stretchable fabric. The fabric wrapping the foam material may be sewn together or bound using adhesives for securing the foam material. This configuration makes the harness member 200 flexible thereby mitigating any discomfort that may be caused to the animal 100 due to movement such as, walking or any physical activity. In one example, a piece of breathable fabric is used for designing the harness member 200. However, it shall be apparent that any fabric that meets design requirements and functionality may be used for the harness member 200.

In an embodiment, the harness member 200 includes a plurality of leg strap members 208 (hereinafter referred to as ‘leg strap members 208’) extending from a bottom end 206d of each of a left arm 206a and a right arm 206b of the opening 204. The leg strap members 208 are configured to wrap around at least the hind legs 104 of the animal 100 thus leading the hind legs 104 through each of the leg strap members 208. More specifically, an owner must assist the animal 100 by leading their hind legs 104 through the leg strap members 208 so that the leg strap members 208 are located around a top part of the hind legs 104. The leg strap members 208 are adapted to releasably engage with a fastening means 210 configured at the proximal portion 202a for mounting the harness member 200 to the body of the animal 100. The leg strap members 208 may be made of a pliable material or an elastic material that provides flexibility and enables free movement of the animal 100. More specifically, the leg strap members 208 may be designed using any material with an elastic property that may change length or size when a force is applied (i.e., when the animal moves). Additionally, the leg strap members 208 are adjusted or extended suitably so as to completely wrap around the hind legs 104 and releasably engage with the fastening means 210. These adjustable leg strap members 208 are designed to adapt with varied thigh lengths of different animals and ensures a comfortable fit when the harness member 200 is mounted on the animal 100. In other words, the leg strap members 208 are adjusted such that they do not limit the mobility of the hind legs 104 of the animal 100.

In an example embodiment, the fastening means 210 is a buckle strap member. Examples of the fastening means 210 may include, but are not limited to, snap buttons, Velcro™ straps, a clip, a loop, and the like that are adaptable to ensure the harness member 200 fits a variety of animals. Accordingly, the leg strap members 208 may also be designed with snap buttons, Velcro™ straps, a clip, a loop based on the fastening means 210 for securing the harness member 200 to the animal 100. In one embodiment, the leg strap members 208 may be configured with one or more buckle slots at predefined intervals and the fastening means 210 may include a buckle pin (i.e., the buckle strap member). In this case, a length of the leg strap members 208 may be adjusted by suitably engaging the buckle pin with a buckle slot of the one or more buckle slots, such that the animal 100 can move the hind legs 104 without any hindrance.

In an alternate embodiment, the leg strap members 208 extending from the bottom end 206d (see, the enlarged portion 205) may be sewed to the proximal portion 202a of the harness member 200. The owner may assist the animal 100 to insert the hind legs 104 in a corresponding passage provided by the leg strap members 208 for mounting the harness member 200 to the animal 100.

The harness member 200 may optionally include an adjustable strap member 212. In one embodiment, the adjustable strap member 212 may be used for animals that possess no tail or a short tail. In such cases, the adjustable strap member 212 may be used to connect the harness member 200 to the collar 116 which prevents the harness member 200 from coming off the hind end 102 of the animal 100 when worn by the animal 100. The adjustable strap member 212 includes a first end 212a secured to the proximal portion 202a and the second end 212b configured with a fastening mechanism 214 to releasably engage with a securing element (not shown in FIGS. 2A-2B) configured on the collar 116 secured to the neck 106 of the animal 100.

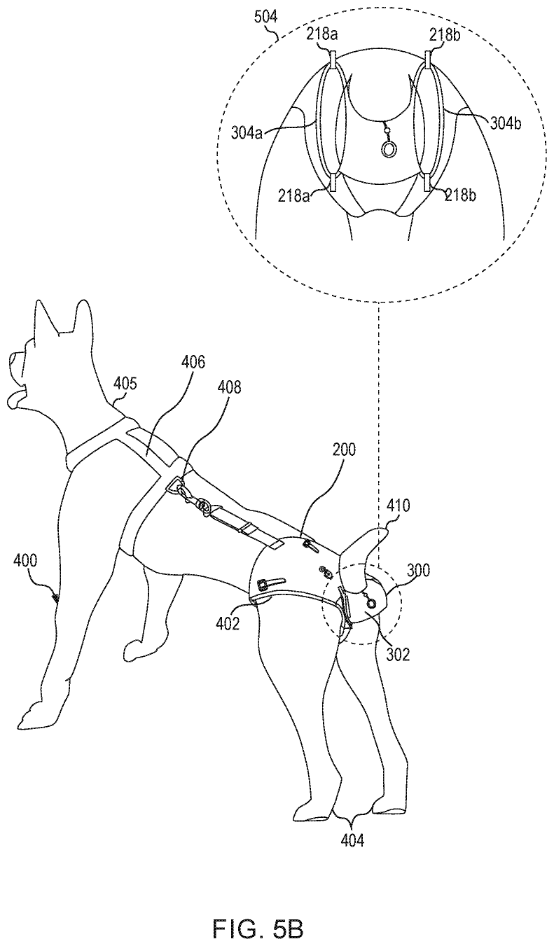

Further, a length of the adjustable strap member 212 may be adjusted for engaging the fastening mechanism 214 with the securing element (see, 408 in FIG. 4) to tightly secure the harness member 200 to the body of the animal 100. More specifically, the length of the adjustable strap member 212 is adjusted based on the torso length 107 of the animal 100. The torso length 107 of the animal 100 is a distance from a lower neck to the loin or a length of the back of the animal 100. The length of the adjustable strap member 212 may be selected to be greater than the torso length 107 of the animal 100 so as to adjust the adjustable strap member 212 to adapt to variable lengths based on the size of the animal 100. The fastening mechanism 214 may include a tie-down ring 214a secured to the second end 212b of the adjustable strap member 212. The tie-down ring 214a is used primarily as lashing points. For example, the tie-down ring 214a may include but is not limited to D rings, anchor rings, surface mount rings and the like. Further, the fastening mechanism 214 includes a bolt snap member 214b secured to the tie-down ring 214a. The securing element (see, 408 of FIG. 4) may also be a tie-down ring, such as the tie-down ring 214a for securing the bolt snap member 214b to the collar 116. As such, the bolt snap member 214b engages with the securing element 408 for connecting the harness member 200 to the collar 116 and thereby ensuring a tight and secure fit of the harness member 200 to the animal 100.

In an embodiment, the adjustable strap member 212 includes a strap keeper 216. The strap keeper 216 is slidably mounted to the adjustable strap member 212 and configured to tightly secure a remaining length of the adjustable strap member 212 upon adjustment of the length for engaging the fastening mechanism 214 to the securing element 408. In other words, the strap keeper 216 ensures that any length of loose strap of the adjustable strap member 212 on adapting to fit the torso length 107 of the animal 100 will be kept tight and secure. For example, the length of the adjustable strap member 212 maybe 30 centimeters, and the length of the torso (i.e., the torso length 107) of the animal may be 20 centimeters. In this example scenario, the length of the adjustable strap member 212 may be adjusted to 20 centimeters for tightly securing the harness member 200 to the securing element so as to snugly fit onto the body of the animal 100. Further, the remaining length (i.e., 10 centimeters) of the adjustable strap member 212 is folded and secured by the strap keeper 216 (see, FIGS. 2A and 2B).

In some example embodiments, the adjustable strap member 212 may be made of flexible materials, which can elongate or expand corresponding to the torso length 107 of the animal 100 ensuring a snug and comfortable fit of the harness member 200 when the animal 100 moves around. This configuration with elastic or flexible material mitigates the usage of the strap keeper 216 due to the elasticity of the adjustable strap member 212.

As shown in the enlarged portion 205, the harness member 200 includes a first hook member 218a and a second hook member 218b. The first hook member 218a and the second hook member 218b are configured proximate to a top end 206c and the bottom end 206d of each of the left arm 206a and the right arm 206b of the opening 204, respectively. The first hook member 218a and the second hook member 218b are hereinafter interchangeably referred to as ‘the hook members 218a and 218b’. In other words, the hook members 218a and 218b mounted proximate to the top end 206c are located above the tail 105 of the animal 100. Further, the hook members 218a and 218b mounted proximate to the bottom end 206d are located below the anal area of the animal 100. In one non-limiting example, the hook members 218a and 218b mounted at the bottom end 206d may be located approximately 2.5 inches below the anal area of the animal 100. The dimensions pertaining to the distance of the hook members 218a and 218b from the opening 204 may be determined when the harness member 200 is secured to the animal 100. Moreover, these dimensions may vary based on breed, age, and size of the animal. The variation in the dimensions is due to the flexible property of the harness member 200 which snugly fits at the hind end 102 or posterior side when mounted to the animal 100.

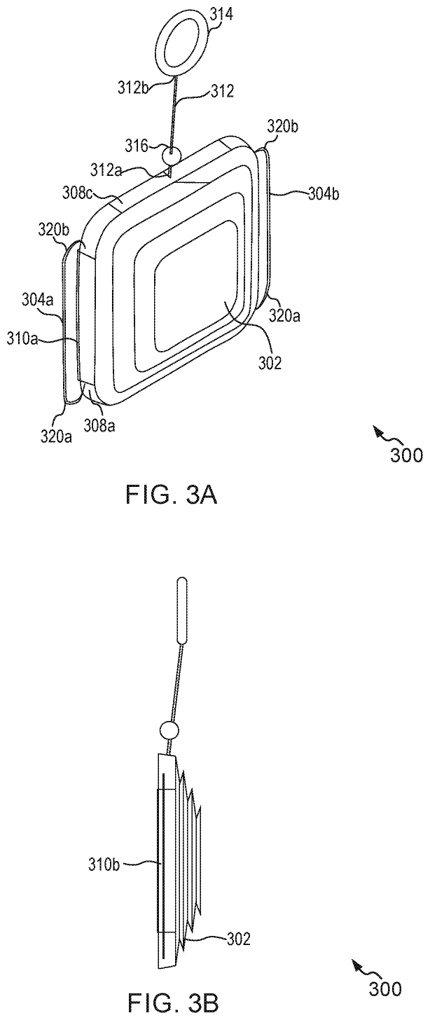

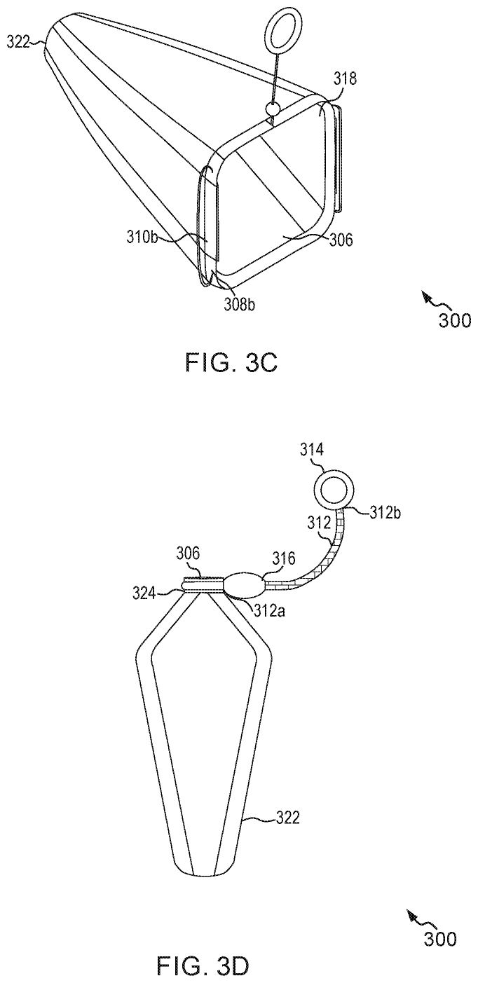

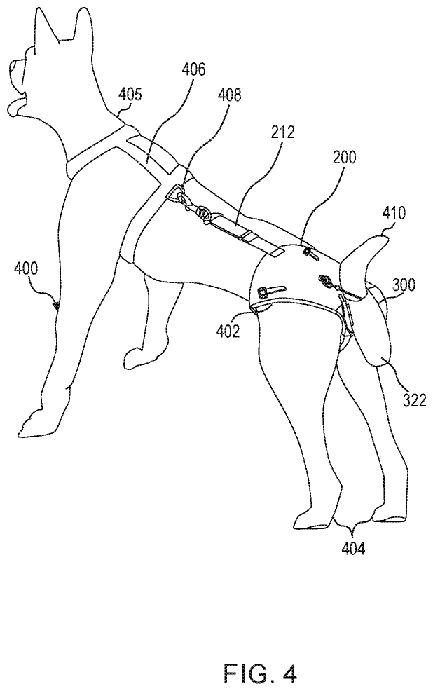

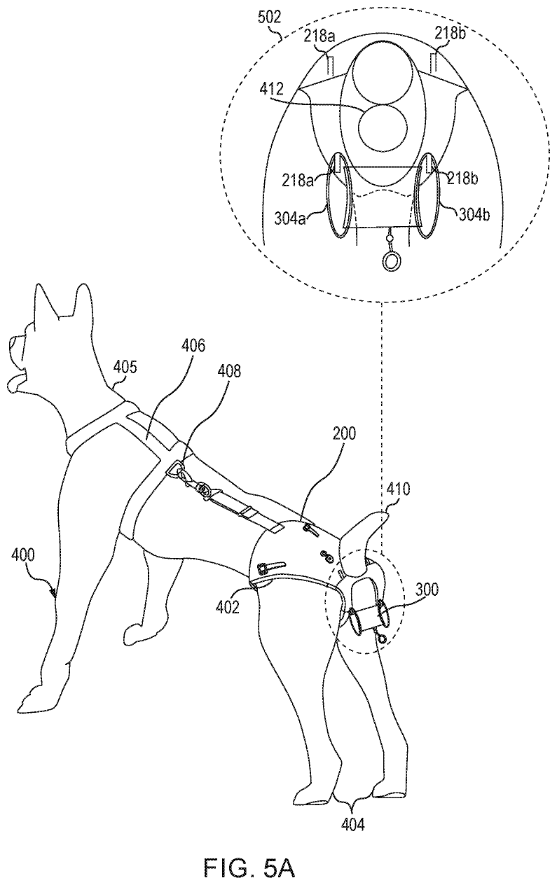

In an embodiment, each of the hook members 218a and 218b is mounted at an angle relative to an exposed surface 220 of the harness member 200. For example, the hook members 218a and 218b may be angled from a range of about 0 to 250 degrees relative to the exposed surface 220 of the harness member 200. Additionally, each of the hook members 218a and 218b mounted at the top end 206c and the bottom end 206d is oriented in an upward direction and downward direction, respectively (see, FIG. 2A). The hook members 218a and 218b are securing means and are adapted for mounting a waste collection bag (e.g., the waste collection bag 114) to the harness member 200. An example of the waste collection bag 114 is shown and explained with reference to FIGS. 3A-3D.

Examples of the securing means (i.e., the hook members 218a and 218b) in the harness member 200 maybe, but not limited to a Velcro™, a snap button, a button, a buckle type arrangement or any other means which securely mounts the waste collection bag 114 to the harness member 200.

FIGS. 3A, 3B, 3C, and 3D in one exemplary embodiment of the present disclosure illustrate a waste collection bag 300 for collecting excrement of an animal, such as the animal 100. The waste collection bag 300 is an example of the waste collection bag 114 shown and explained with reference to FIG. 1.

The waste collection bag 300 is removably mounted to the harness member 200 for collecting the excrement from the anal area of the animal 100. In one form, the waste collection bag 300 may be made from materials such as, but not limited to a paper, a plastic, a fabric, or any combination thereof, as per the design feasibility and requirement. The waste collection bag 300 may be biodegradable or non-biodegradable. In one example, the waste collection bag 300 is disposable. In other words, the waste collection bag 300 may be disposed of after a one time use or when the excrement has filled the bag 300. In another example, the waste collection bag 300 is reusable such that the waste collection bag 300 may be reused after disposal of the excrement. In an embodiment, the waste collection bag 300 may be permanently attached to the harness member 200, via means such as but not limited to stitching, seaming, or any other means as per the design feasibility and requirement. In such configurations, the excrement of the animal 100 is disposed of by suitable means when the harness member 200 is disengaged from the animal 100.

In one embodiment, the waste collection bag 300 is configured to assume at least one of a collapsed form 302 and an expanded form 322. More specifically, the waste collection bag 300 is initially mounted to the harness member 200 in a collapsed form 302 (shown in FIGS. 3A and 3B) for collecting the excrement. The waste collection bag 300 conceals the opening 204 exposing the anal area of the animal 100 in the collapsed form 302 (see, FIG. 1). In the collapsed form 302, an actual length of the waste collection bag 300 is contracted. In an embodiment, the waste collection bag 300 in the collapsed form 302 conforms to a hose-type configuration. In this configuration, the actual length of the waste collection bag 300 may be contracted to several convolutions (see, 302 in FIG. 3B). The waste collection bag 300 is configured to assume the expanded form (see, 322 of FIG. 3C) upon receiving the excrement of the animal 100. The waste collection bag 300 assumes the expanded form 322 based on amount of excrement in the waste collection bag 300. In one embodiment, the waste collection bag 300 may be a pouch that is devoid of contractions and hence does not assume the collapsed form 302 and/or the expanded form 322.

As shown in FIGS. 3A-3D, the waste collection bag 300 includes a first strap member 304a and a second strap member 304b (hereinafter interchangeably referred to as ‘strap members 304a and 304b’). The strap members 304a and 304b are configured proximate to an aperture 306 on a first side 308a and a second side 308b of the waste collection bag 300, respectively. The strap members 304a and 304b correspond to a mounting means for mounting the waste collection bag 300 to the harness member 200. More specifically, the strap members 304a and 304b are adapted to be scalable based on the position of the hook members 218a and 218b, in order to snugly mount the waste collection bag 300 to the harness member 200. In other words, the strap members 304a and 304b may be stretched suitably based on the distance between the hook members 218a and 218b located at the top end 206c and the bottom end 206d, thereby ensuring a secure and tight fit for the waste collection bag 300. The strap members 304a and 304b may be made from an elastic material. In one embodiment, the mounting means for the waste collection bag 300 may be selected based on a type of fasteners or securing means (i.e., the hook members 218a and 218b) configured proximate to the opening 204 of the harness member 200. Examples of the mounting means may include, but are not limited to, a Velcro™, a snap button, a button, a buckle type arrangement, and the like.

The waste collection bag 300 conceals the opening 204 and ensures complete entrapment of the anal area of the animal 100 when mounted to the harness member 200. In other words, the waste collection bag 300 is mounted to cover the opening 204, such that the aperture 306 is juxtaposed to the anal area for receiving the excrement of the animal 100. Further, the strap members 304a and 304b provide sufficient reinforcement and rigidity to the waste collection bag 300 irrespective of the amount of excrement filled in the waste collection bag 300 and also prevent a collapse of the waste collection bag 300 during use.

Additionally, the waste collection bag 300 may include a first cardboard member 310a and a second cardboard member 310b mounted on the first side 308a and the second side 308b, respectively. The cardboard members 310a and 310b are adapted to ensure proper entrapment of the anal area and prevent the excrement from coming out through the aperture 306 of the waste collection bag 300.

The waste collection bag 300 includes a string member 312 including a proximal end 312a and a distal end 312b. The proximal end 312a of the string member 312 is secured to a third side 308c of the waste collection bag 300 and located proximate to the aperture 306. Further, a ring member 314 is mounted to the distal end 312b of the string member 312. Upon mounting the waste collection bag 300 to the harness member 200, the ring member 314 is releasably engaged with a latching member 222 configured on a central portion 202c of the harness member 200. More specifically, the distal end 312b of the string member 312 is pulled towards the latching member 222 for engaging the ring member 314 to the latching member 222. Further, engagement of the ring member 314 with the latching member 222 seals the waste collection bag 300 such that it completely covers the opening 204 that exposes the anal area. The string member 312 has a length that conforms to a distance between the latching member 222 located on the harness member 200 and the opening 204, to ensure complete entrapment of the anal area of the animal 100. The ring member 314 may also be used as an aid to carry the waste collection bag 300. The string member 312 including the ring member 314 for engaging with the latching member 222 conforms to a hook-latch configuration. In one embodiment, the string member 312 may be designed using elastic materials to provide flexibility to the string member 312. As such, the string member 312 may be stretched to a location of the latching member 222 when the harness member 200 is worn on the animal 100. Alternatively, the string member 312 may be designed using any other materials which serve the design feasibility and requirement.

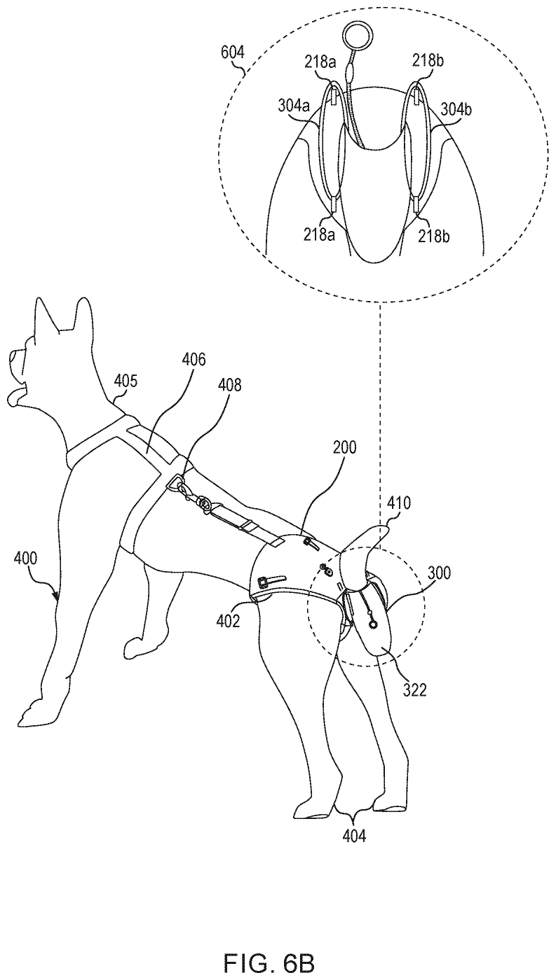

Further, a closure member 316 is slidably mounted to the string member 312. The closure member 316 is adapted to move along the length of the string member 312 for configuring the waste collection bag 300 to an open position (see, 318 of FIG. 3C) and a closed position (see, 324 of FIG. 3D). The waste collection bag 300 is configured to assume the open position 318, when the closure member 316 is moved towards the distal end 312b of the string member 312. At this position, the waste collection bag 300 is configured to receive the excrement of the animal 100 through the aperture 306. In other words, the waste collection bag 300 assumes the collapsed form 302 when mounted in the open position 318 to the harness member 200 for receiving the excrement. Alternatively, the waste collection bag 300 is configured to assume the closed position 324, when the closure member 316 is moved beyond the proximal end 312a of the string member 312 in the expanded form 322. Upon collection of the excrement, the waste collection bag 300 is sealed by operating the closure member 316 which is explained in detail with reference to FIGS. 6A and 6B. In another embodiment, the waste collection bag 300 may include a Ziploc means or any other suitable means for configuring the waste collection bag 300 to the open position 318 and the closed position 324.

FIG. 4 illustrates a schematic representation of the animal waste collection wearable 110 with the waste collection bag 300 in the extended form indicating a collection of the excrement of the animal 100, in accordance with an example embodiment of the present disclosure. In an example, a dog 400 (i.e., the animal 100) is mounted with the animal waste collection wearable 110.

As shown in FIG. 4, the dog 400 is mounted with the harness member 200 that is connected to a collar 406 secured to a neck 405 of the dog 400. It shall be apparent that the harness member 200 may be mounted to any domestic animal with similar body structure as that of the dog 400 for collecting the excrement in the waste collection bag 300 mounted to the harness member 200. Accordingly, a configuration of the harness member 200 may be adapted to conform to the body structure of any other animal onto which the harness member 200 is mounted. Additionally, the waste collection bag 300 may be configured based on the dimensions of the opening 204 in the harness member 200 and/or the size of the dog 400 such that it completely covers an anal area (see, 412 in FIG. 5A) of the dog 400.

The harness member 200 is mounted to the dog 400 by wrapping the leg strap members 208 around hind legs 404 of the dog 400 and securing the leg strap members 208 at the top part of the hind legs 404 of the dog 400. Additionally, the harness member 200 is connected to the collar 406 by using the adjustable strap member 212 for a tight and secure fit of the harness member 200 to the dog 400. In an embodiment, the adjustable strap member 212 may be used to tightly secure the harness member 200 to the dog 400 with a short tail or no tail thus preventing the harness member 200 from coming off the hind end 402 of the dog 400. As shown in FIG. 4, the opening 204 is butted up and fits snugly against a tail 410 of the dog 400 which holds the harness member 200 in place and prevents the harness member 200 from coming off the hind end 402.

In addition, the collar 406 includes a securing element 408 that may be configured to receive a leash (not shown in FIGS) that is held by the owner for controlling the dog 400. The leash may include a fastener for releasably engaging with the securing element 408. In one non-limiting example, the fastener is a bolt snap that is clipped to secure the leash with the collar 406.

The waste collection bag 300 is mounted to the harness member 200 secured on the dog 400 in the collapsed form 302 (see, FIG. 1). The waste collection bag 300 conceals the opening 204 that exposes the anal area 412 of the dog 400 for collecting the excrement.

As shown in FIG. 4, the waste collection bag 300 mounted to the harness member 200 expands from the collapsed form 302 to the expanded form 322 as it receives excrement from the anal area 412 of the dog 400. The length of the waste collection bag 300 in the expanded form 322 depends upon an amount of excrement collected in the waste collection bag 300. After the dog 400 defecates, the waste collection bag 300 is detached from the harness member 200. An example of mounting and detaching the waste collection bag 300 to and from the harness member 200 is explained in detail with reference to FIGS. 5A-5B and 6A-6B.

FIGS. 5A and 5B represent a stepwise process for mounting the waste collection bag 300 to the harness member 200 secured on the animal (i.e., the dog 400). The waste collection bag 300 is positioned such that the string member 312 including the ring member 314 is at a vicinity of the tail 410 of the animal 400 for engaging with the latching member 222. Further, the strap members 304a and 304b should be in conformity with the hook members 218a and 218b for mounting the waste collection bag 300 to the harness member 200.

Initially, a primary end 320a (see, FIG. 3B) of each of the strap members 304a and 304b is inserted to the hook members 218a and 218b located proximate to the bottom end 206d of each of the left arm 206a and the right arm 206b, respectively (see, enlarged portion 502 shown in FIG. 5A). Subsequently, a secondary end 320b of each of the strap members 304a and 304b is inserted to the hook members 218a and 218b located proximate to the top end 206c of each of the left arm 206a and the right arm 206b, respectively (see, enlarged portion 504 shown in FIG. 5B). In addition, while securing the strap members 304a and 304b to the hook members 218a and 218b, the owner must ensure that the string member 312 is exposed away from the aperture 306. Upon engaging the strap members 304a and 304b, the ring member 314 is engaged with the latching member 222 to conceal the opening 204. Thus, the waste collection bag 300 is mounted to the harness member 200 in the collapsed form 302 for collecting the excrement of the animal 400 (shown in FIG. 1).

FIGS. 6A and 6B represent a process for disengaging or detaching the waste collection bag 300 from the harness member 200 secured to the animal 400. The waste collection bag 300 is disengaged from the harness member 200 when it is filled with the excrement of the animal 400.

After the animal 400 defecates, the ring member 314 is disengaged from the latching member 222 for detaching the waste collection bag 300 (see, enlarged portion 602 shown in FIG. 6A). As shown in FIG. 6A, the secondary end 320b of each of the strap members 304a and 304b is disengaged from the hook members 218a and 218b located proximate to the top end 206c of each of the left arm 206a and the right arm 206b, respectively. Subsequently the primary end 320a of each of the strap members 304a and 304b is disengaged from the hook members 218a and 218b located proximate to the bottom end 206d of each of the left arm 206a and the right arm 206b, respectively (see, enlarged portion 604 shown in FIG. 6B). More specifically, the strap members 304a and 304b detach from the hook members 218a and 218b located proximate to the bottom end 206d due to the weight of the waste collection bag 300 filled with excrement. Thus, prior to detaching the secondary end 320b, the owner must grab the ring member 314 to prevent the dropping of the waste collection bag 300. Upon detachment, the waste collection bag 300 is sealed by operating the closure member 316 to move beyond the proximal end 312a, thus configuring the waste collection bag to the closed position 324 (see, FIG. 3D).

Various embodiments of the disclosure, as discussed above, may be practiced with steps and/or operations in a different order, and/or with hardware elements in configurations, which are different than those which, are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. An animal waste collection wearable, comprising:
a harness member configured for mounting to a body of an animal, the harness member configured to cover at least a portion of a hind end of the animal, the harness member comprising:
an opening at a distal portion of the harness member, the opening configured to expose a tail and an anal area of the animal when the harness member is secured to the body of the animal,
a plurality of leg strap members configured to wrap around at least hind legs of the animal, the plurality of leg strap members extending from a bottom end of each of a left arm and a right arm of the opening and releasably engage with a fastening means at a proximal portion of the harness member for mounting the harness member to the body of the animal, and
a first hook member and a second hook member configured proximate to a top end and the bottom end of each of the left arm and the right arm of the opening, respectively; and
a waste collection bag removably mounted at the distal portion of the harness member through the first hook member and the second hook member to conceal the opening and for complete entrapment of the anal area of the animal, wherein the waste collection bag is configured to collect excrement of the animal.

2. The animal waste collection wearable as claimed in claim 1, wherein the waste collection bag comprises:
a first strap member and a second strap member configured on a first side and a second side of the waste collection bag, respectively, the first strap member and the second strap member adapted to releasably engage with the first hook member and the second hook member, respectively for mounting the waste collection bag to the harness member.

3. The animal waste collection wearable as claimed in claim 2, wherein the waste collection bag is configured to assume at least one of a collapsed form and an expanded form, wherein
the waste collection bag conceals the opening exposing the anal area of the animal in the collapsed form and assumes the expanded form when the excrement of the animal enters the waste collection bag from the anal area of the animal.

4. The animal waste collection wearable as claimed in claim 2, wherein the waste collection bag further comprises:
an aperture configured to receive the excrement of the animal;
a string member configured proximate to the aperture, wherein a proximal end of the string member is secured to a third side of the waste collection bag;
a ring member configured on a distal end of the string member, the ring member configured to releasably engage with a latching member mounted on a central portion of the harness member; and
a closure member slidably mounted to the string member and adapted to move along a length of the string member for configuring the waste collection bag to an open position and a closed position, wherein the waste collection bag receives the excrement of the animal through the aperture in the open position and the waste collection bag filled with the excrement is sealed upon detaching from the harness member in the closed position.

5. The animal waste collection wearable as claimed in claim 4, wherein the waste collection bag further comprises a first cardboard member and a second cardboard member configured on the first side and the second side of the waste collection bag, respectively, the first cardboard member and the second cardboard member configured for proper entrapment of the anal area and for preventing the excrement from coming out through the aperture.

6. The animal waste collection wearable as claimed in claim 1, wherein the opening is an inverted U-shaped structure when the harness member is mounted to the animal.

7. The animal waste collection wearable as claimed in claim 1, wherein the harness member further comprises an adjustable strap member including a first end secured to the proximal portion of the harness member and a second end configured with a fastening mechanism to releasably engage with a securing element configured on a collar secured to a neck of the animal, wherein the fastening mechanism is engaged with the securing element by adjusting a length of the adjustable strap member based on a torso length of the animal.

8. The animal waste collection wearable as claimed in claim 7, wherein the adjustable strap member comprises a strap keeper, the strap keeper configured to secure a remaining length of the adjustable strap member upon adjustment of the length of the adjustable strap member.

9. The animal waste collection wearable as claimed in claim 1, wherein the first hook member and the second hook member are mounted at an angle relative to an exposed surface of the harness member.

10. The animal waste collection wearable as claimed in claim 1, wherein the harness member is of a pentagon-shaped structure.

11. An animal waste collection wearable, comprising:
a harness member configured for mounting to a body of an animal, the harness member configured to cover at least a portion of a hind end of the animal, the harness member comprising:
an opening at a distal portion of the harness member, the opening configured to expose a tail and an anal area of the animal when the harness member is secured to the body of the animal,
a plurality of leg strap members configured to wrap around at least hind legs of the animal, the plurality of leg strap members extending from a bottom end of each of a left arm and a right arm of the opening and releasably engage with a fastening means at a proximal portion of the harness member for mounting the harness member to the body of the animal, and
a first hook member and a second hook member configured proximate to a top end and the bottom end of each of the left arm and the right arm of the opening, respectively; and
a waste collection bag removably mounted at the distal portion of the harness member through the first hook member and the second hook member to conceal the opening and for complete entrapment of the anal area of the animal, wherein the waste collection bag is configured to collect excrement of the animal, the waste collection bag comprising:
a first strap member and a second strap member configured on a first side and a second side of the waste collection bag, respectively, the first strap member and the second strap member adapted to releasably engage with the first hook member and the second hook member, respectively, for mounting the waste collection bag to the harness member.

12. The animal waste collection wearable as claimed in claim 11, wherein the waste collection bag is configured to assume at least one of a collapsed form and an expanded form, wherein the waste collection bag conceals the opening exposing the anal area of the animal in the collapsed form and assumes the expanded form when the excrement of the animal enters the waste collection bag from the anal area of the animal.

13. The animal waste collection wearable as claimed in claim 11, wherein the waste collection bag further comprises:
an aperture configured to receive the excrement of the animal;
a string member configured proximate to the aperture, wherein a proximal end of the string member is secured to a third side of the waste collection bag;
a ring member configured on a distal end of the string member, the ring member configured to releasably engage with a latching member mounted on a central portion of the harness member; and
a closure member slidably mounted to the string member and adapted to move along a length of the string member for configuring the waste collection bag to an open position and a closed position, wherein the waste collection bag receives the excrement of the animal through the aperture in the open position and the waste collection bag filled with the excrement is sealed upon detaching from the harness member in the closed position.

14. The animal waste collection wearable as claimed in claim 11, wherein the waste collection bag further comprises a first cardboard member and a second cardboard member configured on the first side and the second side of the waste collection bag, respectively, the first cardboard member and the second cardboard member configured for proper entrapment of the anal area and for preventing the excrement from coming out through the aperture.

15. The animal waste collection wearable as claimed in claim 11, wherein the opening is an inverted U-shaped structure when the harness member is mounted to the animal.

16. An animal waste collection wearable, comprising:
a harness member configured for mounting to a body of an animal, the harness member configured to cover at least a portion of a hind end of the animal, the harness member comprising:
an opening at a distal portion of the harness member, the opening configured to expose a tail and an anal area of the animal when the harness member is secured to the body of the animal,
a plurality of leg strap members configured to wrap around at least hind legs of the animal, the plurality of leg strap members extending from a bottom end of each of a left arm and a right arm of the opening and releasably engage with a fastening means at a proximal portion of the harness member for mounting the harness member to the body of the animal,
an adjustable strap member including a first end secured to the proximal portion of the harness member and a second end configured with a fastening mechanism to releasably engage with a securing element configured on a collar secured to a neck of the animal, wherein the fastening mechanism is engaged with the securing element by adjusting a length of the adjustable strap member based on a torso length of the animal, and
a first hook member and a second hook member configured proximate to a top end and the bottom end of each of the left arm and the right arm of the opening respectively; and
a waste collection bag removably mounted at the distal portion of the harness member through the first hook member and the second hook member to conceal the opening and for complete entrapment of the anal area of the animal, wherein the waste collection bag is configured to collect excrement of the animal, the waste collection bag comprising:
a first strap member and a second strap member configured on a first side and a second side of the waste collection bag respectively, the first strap member and the second strap member adapted to releasably engage with the first hook member and the second hook member respectively, for mounting the waste collection bag to the harness member.

17. The animal waste collection wearable as claimed in claim 16, wherein the waste collection bag further comprises:
an aperture configured to receive the excrement of the animal;
a string member configured proximate to the aperture, wherein a proximal end of the string member is secured to a third side of the waste collection bag;
a ring member configured on a distal end of the string member, the ring member configured to releasably engage with a latching member mounted on a central portion of the harness member; and
a closure member slidably mounted to the string member and adapted to move along a length of the string member for configuring the waste collection bag to an open position and a closed position, wherein the waste collection bag receives the excrement of the animal through the aperture in the open position and the waste collection bag filled with the excrement is sealed upon detaching from the harness member in the closed position.

18. The animal waste collection wearable as claimed in claim 17, wherein the waste collection bag is configured to assume at least one of a collapsed form and an expanded form, wherein the waste collection bag conceals the opening exposing the anal area of the animal in the collapsed form and assumes the expanded form when the excrement of the animal enters the waste collection bag from the anal area of the animal.

19. The animal waste collection wearable as claimed in claim 17, wherein the waste collection bag further comprises a first cardboard member and a second cardboard member configured on the first side and the second side of the waste collection bag, respectively, the first cardboard member and the second cardboard member configured for proper entrapment of the anal area and for preventing the excrement coming out from the aperture of the waste collection bag.

20. The animal waste collection wearable as claimed in claim 16, wherein the opening is an inverted U-shaped structure when the harness member is mounted to the animal.
